(19) United States
(12) Patent Application Publication
(10) Pub. No.: US 2008/0107036 A1
(43) Pub. Date: May 8, 2008

(54) COMMUNICATION RELAY DEVICE, COMMUNICATION RELAY METHOD, AND COMPUTER PRODUCT

(75) Inventors: Yoko Toyozumi, Onojo (JP); Seiji Miyata, Fukuoka (JP); Yumiko Ogata, Fukuoka (JP); Yoshiko Sakamoto, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/934,893

(22) Filed: Nov. 5, 2007

(30) Foreign Application Priority Data
Nov. 7, 2006 (JP) 2006-301802

(51) Int. Cl. G06F 11/00

(52) U.S. Cl. 370/241

(57) ABSTRACT

An evaluation criterion that evaluates a comparison result of a bandwidth before a bandwidth limitation and a bandwidth after the bandwidth limitation is selected and set in advance in a layer 2 (L2) switch device according to the present invention. An input packet is subjected to the bandwidth limitation and then output. The bandwidth before the bandwidth limitation and the bandwidth after the bandwidth limitation are constantly compared. Next, based on the preset evaluation criterion, the comparison result of the bandwidths is constantly evaluated. The evaluation result is output in real time to an input/output terminal such that the evaluation result can be displayed. When the bandwidth that is limited via the bandwidth limitation exceeds a maximum value of an admissible packet-dropping bandwidth that is set in advance, the excess is notified to a user in real time and the user can take quick countermeasures.

### BACKGROUND OF THE INVENTION

1. Field of the Invention

The present invention relates to a communication relay device, a communication relay method, and a computer product that relay in a communication network, input data input from a line to another line as output data, and, more particularly to a communication relay device, a communication relay method, and a computer product that notify a quality deterioration of the communication network in real time and enable communication quality control by causing a user to take quick countermeasures.

2. Description of the Related Art

Recently, along with an increasing use of a computer network such as a local area network (LAN) and the Internet, a flow of traffic (traffic of packets) via a network line is also increasing.

The computer network includes lines that are connected by a relay device. However, when bandwidths of the connected lines differ, a bandwidth of an input line is subjected to a bandwidth limitation to output the packets to an output line. Due to this, regardless of the increase in the traffic via the network line, the packets are smoothly relayed from one line to the other line.

However, carrying out the bandwidth limitation reduces the communication speed and accuracy of the packet transmission, thus resulting in a quality deterioration of the traffic in the computer network. The quality deterioration of the traffic needs to be quickly detected and quick countermeasures need to be taken.

To overcome the drawback, a quality of service (QoS) control system is disclosed in Japanese Patent Application Laid-open No. 2006-148823. The QoS control system can individually set a protocol and communication parameters for each hierarchy of an open systems interconnection (OSI) basic reference model and carry out the QoS control for each hierarchy. Upon detecting a quality deterioration of the traffic in a hierarchy, the QoS control system can automatically update the communication parameters to restore the quality of the traffic.

Further, a traffic control system is disclosed in “Packet Shaper of Packeteer”, (online), library, (searched on Sep. 29, 2006), Internet URL: http://www.packeteer.co.jp/document/packetshaper-ds.pdf. For carrying out the quality control of the traffic according to user's needs, based on criteria such as application, protocol, subnet, uniform resource locator (URL), the traffic control system classifies the traffic in a seventh hierarchy of the OSI basic reference model, analyzes a usage status of the network, application performance, and network efficiency, stores the analysis results, and carries out the bandwidth limitation and compression on the traffic.

However, in the conventional technologies described above, when the traffic is monitored based on a quality control criterion which flexibly deals with the user's needs and the quality deterioration of the traffic is detected as a result of the monitoring, the quality deterioration is not notified to the user in real time and the user cannot take quick countermeasures.

To be specific, in the former conventional technology, a criterion that notifies the quality deterioration of the traffic is a fixed value preset in the QoS control system and the user cannot freely set the criterion according to his or her needs. Therefore, upon detecting that the quality of the traffic in a hierarchy has deteriorated, even if the QoS control system attempts to restore the quality of the traffic by automatically updating the communication parameters, the quality control itself is limited. This is because a range subject to the quality control of the traffic is limited.

Further, in the latter conventional technology, although the user can freely set, according to his or her needs, the criterion that detects the quality deterioration of the traffic, the traffic control system does not notify the user of the detection of the quality deterioration in real time and the user cannot take quick countermeasures.

Further, even if these conventional technologies are combined, the quality deterioration related to the quality of a communication service is not notified to the user in real time according to the user's needs. Thus, the user cannot take quick countermeasures.

### SUMMARY OF THE INVENTION

It is an object of the present invention to at least partially solve the problems in the conventional technology.

According to an aspect of the present invention, a communication relay device that relays in a communication network, input data that is input from a line to another line as output data, includes an evaluation-criterion setting unit that in advance sets, based on the input data and the output data, an evaluation criterion that is arbitrarily set for evaluating a performance of the communication network; an indicator calculating unit that calculates, based on the input data and the output data, a performance indicator of the communication network; and an evaluating unit that evaluates, based on the performance indicator calculated by the indicator calculating unit and the evaluation criterion set in advance by the evaluation-criterion setting unit, the performance of the communication network.

According to another aspect of the present invention, a communication relay device that relays in a communication network, a communication bandwidth of input data that is input from a line and subjected to a bandwidth limitation to a predetermined bandwidth, to another line as output data, includes an evaluation-criterion setting unit that in advance sets an evaluation criterion that is arbitrarily set for evaluating the bandwidth limitation; an indicator calculating unit that calculates a bandwidth limitation indicator based on the communication bandwidth of the input data and one of the predetermined bandwidth and a communication bandwidth of the output data after the bandwidth limitation; and an evaluating unit that evaluates, based on the bandwidth limitation indicator calculated by the indicator calculating unit and the evaluation criterion set in advance by the evaluation-criterion setting unit, the bandwidth limitation.

According to still another aspect of the present invention, a communication relay method of relaying in a communication network, input data that is input from a line to another line as output data, includes setting an evaluation criterion that is arbitrarily set for evaluating a performance of the communication network in advance based on the input data and the output data; calculating a performance indicator of the communication network based on the input data and the output data; and evaluating the performance of the communication network based on the performance indicator calculated in the calculating and the evaluation criterion set in advance in the setting.

According to still another aspect of the present invention, a communication relay method of relaying in a communication network, a communication bandwidth of input data that is input from a line and subjected to a bandwidth limitation to a predetermined bandwidth, to another line as output data, includes setting an evaluation criterion that is arbitrarily set for evaluating the bandwidth limitation in advance; calculating a bandwidth limitation indicator based on the communication bandwidth of the input data and one of the predetermined bandwidth and a communication bandwidth of the output data after the bandwidth limitation; and evaluating the bandwidth limitation based on the bandwidth limitation indicator calculated in the calculating and the evaluation criterion set in advance in the setting.

According to still another aspect of the invention, in a computer-readable recording medium that stores therein a communication relay process program that causes a computer to perform a communication relay process of relaying input data that is input from one line to another line as output data, the communication relay process program causes the computer to execute setting an evaluation criterion that is arbitrarily set for evaluating a performance of the communication network in advance based on the input data and the output data; calculating a performance indicator of the communication network based on the input data and the output data; and evaluating the performance of the communication network based on the performance indicator calculated in the calculating and the evaluation criterion set in advance in the setting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an overview and a salient feature of the present invention;

FIG. 2 is a functional block diagram of an L2 switch device according to a first embodiment of the present invention;

FIG. 3 is a flowchart of a bandwidth limitation evaluating process according to the first embodiment;

FIG. 4 is a schematic of an example of an operation using the bandwidth limitation evaluating process according to the first embodiment;

FIG. 5 is a schematic of an input/output interface according to the first embodiment;

FIG. 6 is a flowchart of a bandwidth limitation evaluating process according to a second embodiment of the present invention;

FIG. 7 is a schematic of an example of an operation using the bandwidth limitation evaluating process according to the second embodiment;

FIG. 8 is a schematic of an input/output interface according to the second embodiment;

FIG. 9 is a schematic of an example of an operation using a bandwidth limitation evaluating process according to a third embodiment of the present invention; and

FIG. 10 is a schematic of an input/output interface according to the third embodiment.

### DETAILED DESCRIPTION OF THE PREFERRED EMBODIMENTS

Exemplary embodiments of the communication relay device, the communication relay method, and the computer-readable recording medium storing the communication relay process program according to the present invention will be explained in detail below with reference to the accompanying drawings. In a first to a third embodiments to be explained below, a packet-dropping bandwidth related to a packet drop using a bandwidth limitation is adopted as a criterion to ensure the quality of traffic. Further, because a bandwidth indicates a volume of data transceiving per unit time, the bandwidth is equivalent to a communication speed. Because a packet drop rate is an amount of data drop per unit time, the packet drop rate is equivalent to a degradation amount of the communication speed. However, the criterion to ensure the quality of the traffic is not to be thus limited, and a break period of the traffic, certainty of data transmission, security level, and the like can also be used as the criterion.

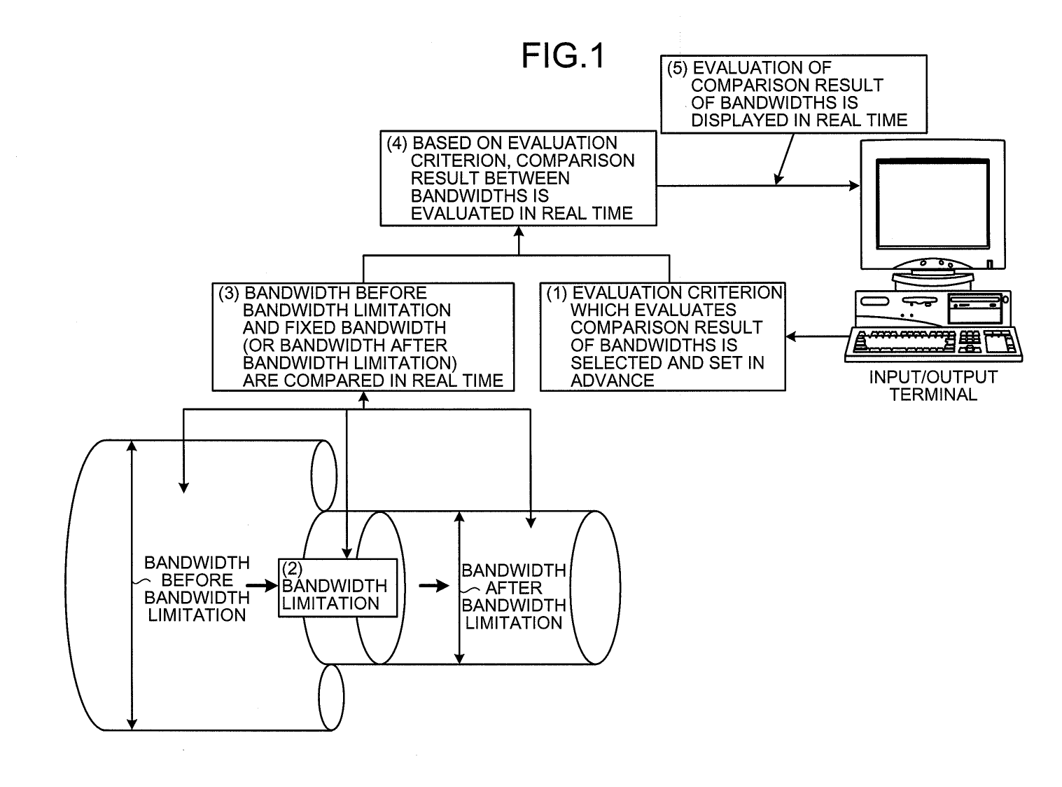

A salient feature of the present invention will be first explained prior to an explanation of the first to the third embodiments. FIG. 1 is a schematic of an overview and the salient feature of the present invention. As shown in FIG. 1, an evaluation criterion which evaluates a comparison result of a bandwidth before the bandwidth limitation and a fixed bandwidth of the bandwidth limitation or a bandwidth after the bandwidth limitation is selected and set in advance ((1) of FIG. 1) from an input/output terminal that is connected to a layer 2 (L2) switch device according to the present invention. The evaluation criterion, for example, is the maximum value of an admissible packet-dropping bandwidth. The evaluation criterion is a parameter that can be selected and set in a predetermined graphical user interface (GUI) to be displayed in the input/output terminal. The evaluation criterion can be freely selected and set according to a user's (network administrator) needs whenever required.

The L2 switch device according to the present invention carries out the bandwidth limitation on an input packet and outputs the input packet ((2) of FIG. 1). Next, the L2 switch device constantly compares the bandwidth before the bandwidth limitation and the fixed bandwidth or the bandwidth after the bandwidth limitation ((3) of FIG. 1). Next, based on the evaluation criterion that is set in advance at (1), the L2 switch device constantly evaluates the comparison result of the bandwidths ((4) of FIG. 1). The evaluation determines, for example, whether a difference between the bandwidth before the bandwidth limitation and the fixed bandwidth or the bandwidth after the bandwidth limitation exceeds the evaluation criterion.

An evaluation result at (4) is then output in real time from the L2 switch device to the input/output terminal such that the evaluation result can be displayed ((5) of FIG. 1). For example, the difference between the bandwidth before the bandwidth limitation and the fixed bandwidth or the bandwidth after the bandwidth limitation is displayed in the predetermined GUI of the input/output terminal based on the output of the comparison result at (5). Further, when the difference between the bandwidth before the bandwidth limitation and the fixed bandwidth or the bandwidth after the bandwidth limitation exceeds the evaluation criterion, such an excess is displayed with a notice.

Due to this, when the bandwidth which is limited using the bandwidth limitation at (2) exceeds the maximum value of the admissible packet-dropping bandwidth that is set in advance at (1), the excess is notified to the user in real time and the user can take quick countermeasures.

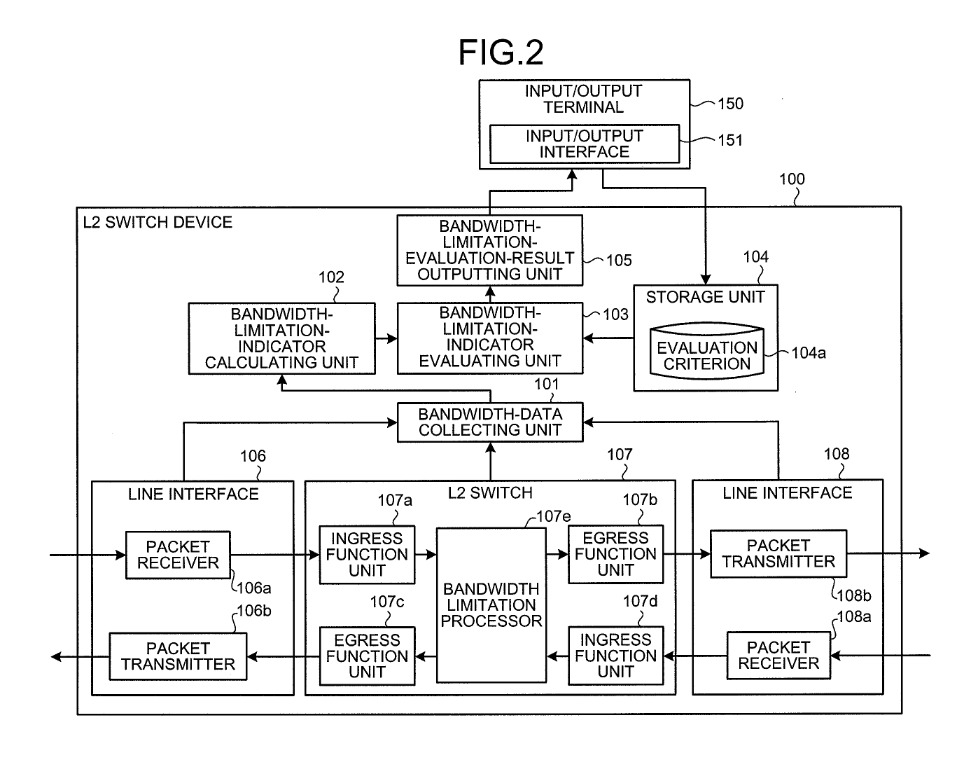

The first embodiment of the present invention will be explained below with reference to FIGS. 2 to 5. In the first embodiment, an upper limit of the admissible packet-dropping bandwidth for the packet drop using the bandwidth limitation of packets is treated as a quality evaluation criterion of the traffic, and the comparison result between the bandwidth before the bandwidth limitation and the fixed bandwidth of the bandwidth limitation in the L2 switch device is output such that the comparison result can be displayed. According to the first embodiment, the difference between the bandwidth before the bandwidth limitation and the fixed bandwidth corresponds to the packet-dropping bandwidth which is a bandwidth of dropped packets. When the difference between the bandwidth before the bandwidth limitation and the bandwidth after the bandwidth limitation exceeds the maximum value of the packet-dropping bandwidth, the L2 switch device can notify such an excess to the user as a warning. In the first embodiment, the maximum value of the packet-dropping bandwidth is treated as the evaluation criterion. A network used in the first embodiment is assumed to be a guarantee type network in which a minimum bandwidth is guaranteed.

A structure of the L2 switch device according to the first embodiment will be explained first. FIG. 2 is a functional block diagram of an L2 switch device 100 according to the first embodiment. The L2 switch device 100 is a communication relay device which carries out a relay and transferring process of data in a layer 2 that is a data link layer in a second hierarchy of an open systems interconnection (OSI) basic reference model. As shown in FIG. 2, the L2 switch device 100 according to the first embodiment includes a bandwidth-data collecting unit 101, a bandwidth-limitation-indicator calculating unit 102, a bandwidth-limitation-indicator evaluating unit 103, a storage unit 104, a bandwidth-limitation-evaluation-result outputting unit 105, a line interface 106, an L2 switch 107, and a line interface 108.

The bandwidth-data collecting unit 101 retrieves bandwidth data from the line interfaces 106 and 108. When the line interface 106 is an input interface to the L2 switch 107 and the line interface 108 is an output interface from the L2 switch 107, the bandwidth-data collecting unit 101 retrieves the bandwidth data of the input packet from the line interface 106 and retrieves the bandwidth data of an output packet after the bandwidth limitation from the line interface 108. Further, when the line interface 108 is the input interface to the L2 switch 107 and the line interface 106 is the output interface from the L2 switch 107, the bandwidth-data collecting unit 101 retrieves the bandwidth data of the input packet from the line interface 108.

The line interface 106 includes a packet receiver 106a that receives the input packet from an external device and a packet transmitter 106b that transmits to the external device, the packet that is supplied from the L2 switch 107. Similarly, the line interface 108 also includes a packet receiver 108a that receives the input packet from the external device and a packet transmitter 108b that transmits to the external device, the packet that is supplied from the L2 switch 107.

The L2 switch 107 which carries out the relay and transferring process of data in the layer 2 includes ingress function units 107a and 107d, egress function units 107b and 107c, and a bandwidth limitation processor 107e. The ingress function unit 107a receives an input of the input packet from the line interface 106, specifies a destination line based on a media access control (MAC) address, and transfers the packet to an egress function unit of the specified destination line. The ingress function unit 107d receives an input of the input packet from the line interface 108, specifies a destination line based on the MAC address, and transfers the packet to the egress function unit of the specified destination line. The bandwidth limitation processor 107e limits, to a predetermined bandwidth, the bandwidth of the packet before the packet is transferred to the egress function unit from the ingress function unit 107a or the ingress function unit 107d. The egress function units 107b and 107c output to the external device via the line interface 106 or the line interface 108, the packet that is subjected to the bandwidth limitation and that is output from the bandwidth limitation processor 107e.

Based on the bandwidth data before the bandwidth limitation and the bandwidth data of the fixed bandwidth that are retrieved by the bandwidth-data collecting unit 101, the bandwidth-limitation-indicator calculating unit 102 calculates a bandwidth limitation indicator that indicates a degree of the bandwidth limitation. In the first embodiment, the difference between the bandwidth data before the bandwidth limitation and the bandwidth data of the fixed bandwidth is treated as the bandwidth limitation indicator. However, the present invention is not to be thus limited, and a difference between the bandwidth data before the bandwidth limitation and the bandwidth data after the bandwidth limitation, or a ratio of the bandwidth data before the bandwidth limitation and the bandwidth data after the bandwidth limitation can also be treated as the bandwidth limitation indicator. Thus, any indicator which can indicate a relation between bandwidths of the bandwidth data before the bandwidth limitation and the bandwidth data after the bandwidth limitation can be used as the bandwidth limitation indicator.

Based on an evaluation criterion 104a stored in the storage unit 104, the bandwidth-limitation-indicator evaluating unit 103 carries out a process to evaluate the bandwidth limitation indicator calculated by the bandwidth-limitation-indicator calculating unit 102. To be specific, when the bandwidth limitation indicator is the difference between the bandwidth data before the bandwidth limitation and the bandwidth data of the fixed bandwidth, the bandwidth-limitation-indicator evaluating unit 103 determines whether the difference exceeds the evaluation criterion. The evaluation criterion 104a indicates at least one of the evaluation criterion which is stored by securing a storage area in a storage unit and the storage area.

The bandwidth-limitation-evaluation-result outputting unit 105 carries out a process to output and display, in an input/output interface 151 of an input/output terminal 150 that is externally connected to the L2 switch device 100, the evaluation result of the bandwidth limitation indicator by the bandwidth-limitation-indicator evaluating unit 103. To be specific, the input/output interface 151 is a GUI that includes a data input function and a data display function, and a control program of the GUI.

A preset value set by selecting the evaluation criterion which is input from the input/output interface 151 of the input/output terminal 150 is stored in the evaluation criterion 104a of the storage unit 104. The preset value can be selected and set whenever required. The value read by the bandwidth-limitation-indicator evaluating unit 103 from the evaluation criterion 104a at the time of carrying out the evaluating process of the bandwidth limitation indicator is treated as the evaluation criterion of the bandwidth limitation indicator. In other words, based on the evaluation criterion that can be modified whenever required, the bandwidth-limitation-indicator evaluating unit 103 evaluates the bandwidth limitation indicator in real time. Thus, the bandwidth-limitation-indicator evaluating unit 103 carries out a timely evaluation.

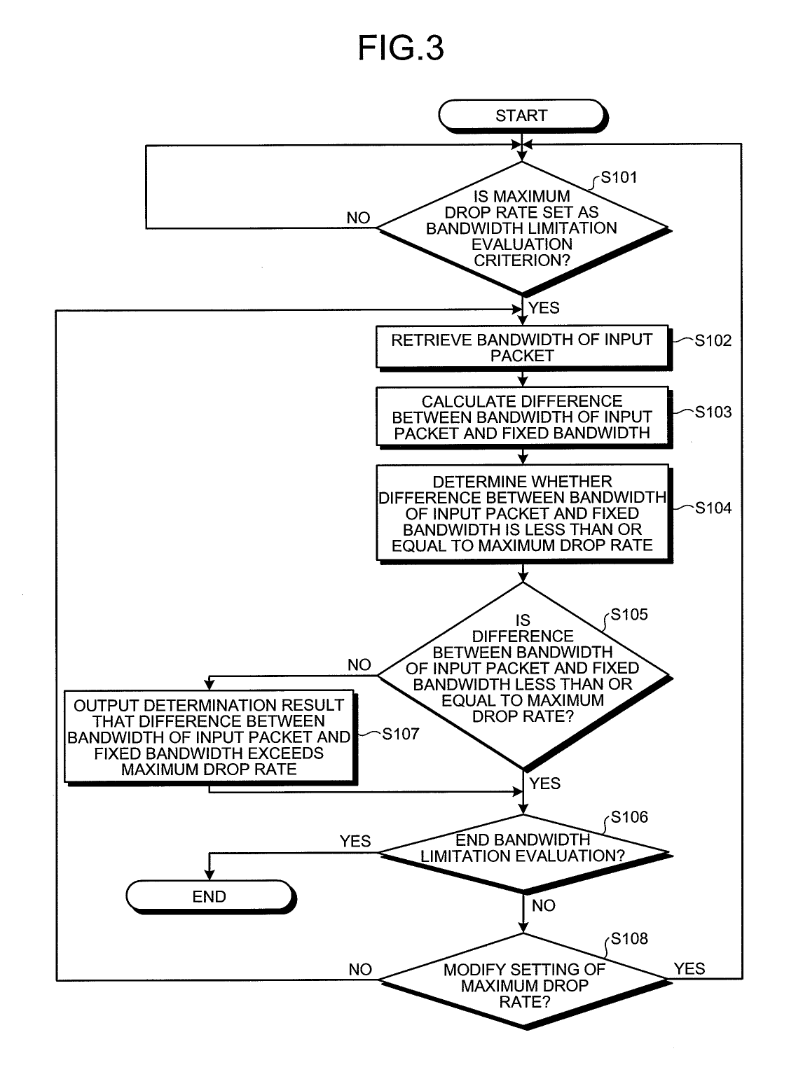

A bandwidth limitation evaluating process according to the first embodiment will be explained next. FIG. 3 is a flowchart of the bandwidth limitation evaluating process. As shown in FIG. 3, first, a not shown controller which controls the entire L2 switch device 100 determines whether a maximum drop rate is set as a bandwidth limitation evaluation criterion (step S101). The bandwidth limitation evaluation criterion is the evaluation criterion 104a that is stored in the storage unit 104 and the maximum drop rate is the maximum value of the admissible packet-dropping bandwidth.

Next, the bandwidth-data collecting unit 101 retrieves the bandwidth of the input packet (step S102). The bandwidth-limitation-indicator calculating unit 102 calculates the difference between the bandwidth of the input packet and the fixed bandwidth (step S103).

Next, the bandwidth-limitation-indicator evaluating unit 103 determines whether the difference between the bandwidth of the input packet and the fixed bandwidth is less than or equal to the maximum drop rate that is the evaluation criterion 104a stored in the storage unit 104 (step S104). When the bandwidth-limitation-indicator evaluating unit 103 determines that the difference between the bandwidth of the input packet and the fixed bandwidth is less than or equal to the maximum drop rate (“Yes” at step S105), the bandwidth limitation evaluating process moves to step S106. When the bandwidth-limitation-indicator evaluating unit 103 determines that the difference between the bandwidth of the input packet and the fixed bandwidth is not less than or equal to the maximum drop rate (“No” at step S105), the bandwidth limitation evaluating process moves to step S107.

At step S106, the controller of the L2 switch device 100 determines whether to end the bandwidth limitation evaluation. When the controller determines to end the bandwidth limitation evaluation (“Yes” at step S106), the controller immediately ends the bandwidth limitation evaluating process. When the controller determines not to end the bandwidth limitation evaluation (“No” at step S106), the bandwidth limitation evaluating process moves to step S108.

At step S107, the bandwidth-limitation-evaluation-result outputting unit 105 outputs the evaluation result to the effect that the difference between the bandwidth of the input packet and the fixed bandwidth exceeds the maximum drop rate. Upon completion of step S107, the bandwidth limitation evaluating process moves to step S106.

At step S108, the controller of the L2 switch device 100 determines whether to modify the setting of the maximum drop rate. When the controller determines to modify the setting of the maximum drop rate (“Yes” at step S108), the bandwidth limitation evaluating process moves to step S101. When the controller determines not to modify the setting of the maximum drop rate (“No” at step S108), the bandwidth limitation evaluating process moves to step S102.

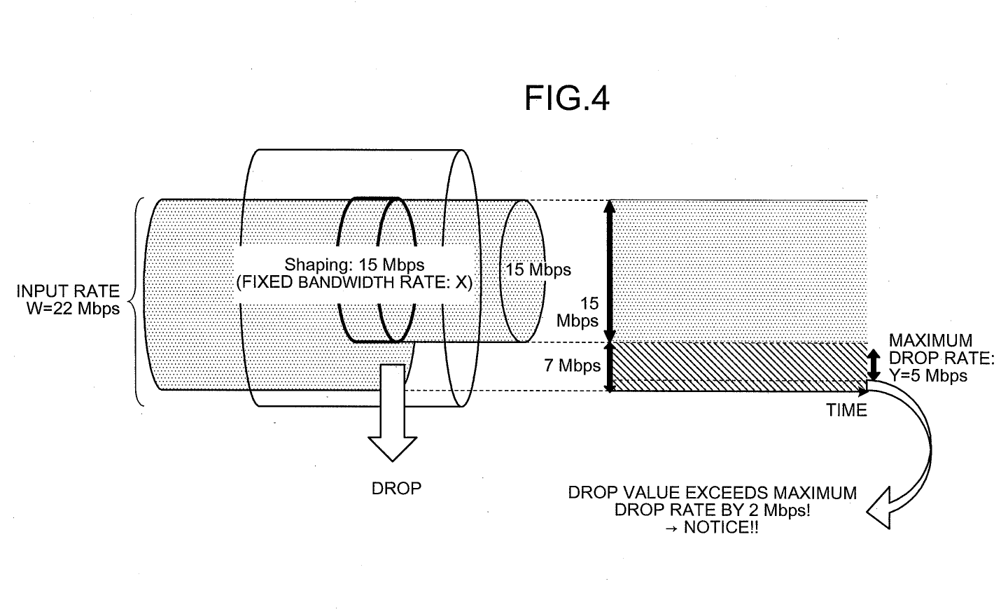

An example of an operation using the bandwidth limitation evaluating process according to the first embodiment will be explained next. FIG. 4 is a schematic of the example of the operation using the bandwidth limitation evaluating process according to the first embodiment. As shown in FIG. 4, when an input rate (the bandwidth of the input packet) is 22 megabits per second (Mbps) and a maximum drop rate is Y=5 Mbps, shaping (bandwidth limitation) is used to limit the bandwidth of the input packet to a fixed bandwidth rate of 15 Mbps. When carrying out the bandwidth limitation, the drop rate is equal to 7 Mbps, which is calculated by subtracting 15 from 22, and the drop rate exceeds the maximum drop rate of Y=5 Mbps by 2 Mbps. Due to the drop rate exceeding the maximum drop rate, a warning is notified to the user. In the first embodiment, the traffic is constantly monitored by using the bandwidth limitation evaluation. Thus, the user can be notified of a defect in the network timely (at the appropriate time) and in real time (immediately).

The first embodiment of the present invention is explained. However, the present invention can be similarly applied to the relay and transferring process of a virtual local area network (VLAN) packet in a VLAN or a virtual private network (VPN) packet in a VPN. When carrying out the relay and transferring process of data, the bandwidth-data collecting unit 101 retrieves the bandwidth data of the input packet and the bandwidth data of the output packet after the bandwidth limitation from the L2 switch 107 that processes the packets in VLAN units or VPN units. For example, a fixed bandwidth rate of X Mbps is stipulated for each VLAN that is identified by a VLAN identification (ID) and shaping (bandwidth limitation) is used to limit an input rate of W Mbps to the fixed bandwidth rate of X Mbps. When Y Mbps is the maximum drop rate, and W-X becomes greater than Y, a warning of such an excess is notified to the user. Further, similarly as the VLAN, the fixed bandwidth rate of X Mbps is stipulated for each VPN that is identified by a VPN identifier and shaping (bandwidth limitation) is used to limit the input rate of W Mbps to the fixed bandwidth rate of X Mbps.

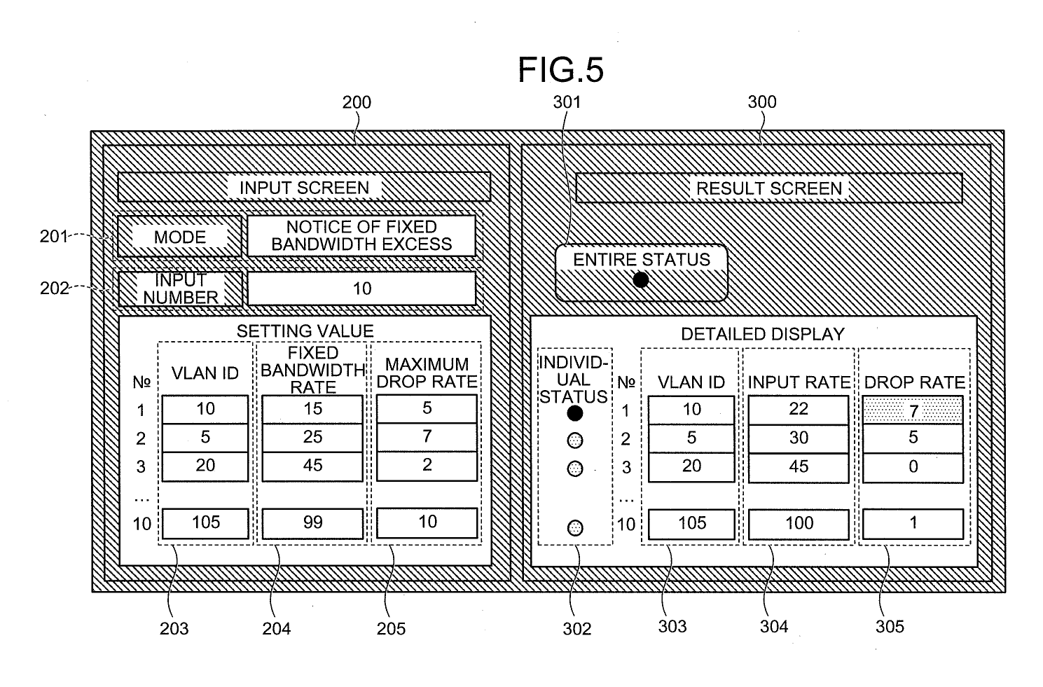

The input/output interface according to the first embodiment will be explained next. FIG. 5 is a schematic of the input/output interface according to the first embodiment. The input/output interface shown in FIG. 5 is a screen image of the input/output interface 151 shown in FIG. 2.

The input/output interface includes an input screen 200 for selecting and setting the evaluation criterion 104a and a result screen 300 for displaying the evaluation result. The input screen 200 and the result screen 300 may be displayed in a single screen. The input screen 200 and the result screen 300 may otherwise be separated to single screens and displayed, respectively.

The input screen 200 includes a mode setting unit 201, an input-number setting unit 202, a VLAN ID setting unit 203, a fixed-bandwidth-rate setting unit 204, and a maximum-drop-rate setting unit 205.

The mode setting unit 201 is an entry that selects and sets any one of “WARNING OF FIXED BANDWIDTH EXCESS”, “NOTICE OF FIXED BANDWIDTH EXCESS”, and “BEST EFFORT”. In the guarantee type network according to the first embodiment, when a guaranteed minimum bandwidth cannot be maintained due to the packet drop, a warning is notified to the user. Therefore in FIG. 5, the “WARNING OF FIXED BANDWIDTH EXCESS” is selected in the input/output interface according to the first embodiment. The “WARNING OF FIXED BANDWIDTH EXCESS” is a mode that sets for each VLAN, the fixed bandwidth as the guaranteed minimum bandwidth and the maximum drop rate as the upper limit that allows the packet drop. When the “WARNING OF FIXED BANDWIDTH EXCESS” mode is selected and the guaranteed minimum bandwidth cannot be maintained due to the packet drop, a warning is notified to the user.

The input-number setting unit 202 is an entry that sets a number of the VLANs to be input. In the example shown in FIG. 5, because the number of the VLAN is “10”, “10” is set in the input-number setting unit 202. According to a setting value in the input-number setting unit 202, “VLAN ID”, “FIXED BANDWIDTH RATE”, and “MAXIMUM DROP RATE” with respect to ten virtual local area networks (VLANs) can be set respectively in the VLAN ID setting unit 203, the fixed-bandwidth-rate setting unit 204, and the maximum-drop-rate setting unit 205 that form a setting unit.

In the VLAN ID setting unit 203, an ID of the VLAN that is subjected to the bandwidth limitation evaluation is set. In the fixed-bandwidth-rate setting unit 204, a minimum bandwidth, which is guaranteed for the VLAN that is subjected to the bandwidth limitation evaluation, is set. In the maximum-drop-rate setting unit 205, an upper limit of the admissible packet drop rate for the VLAN that is subjected to the bandwidth limitation evaluation is set. Thus, with such various setting values, each VLAN is subjected to the bandwidth limitation evaluation and is subjected to a traffic quality monitoring.

In the first embodiment, when the present invention is not applied to the VLAN, “1” is fixedly set in the input-number setting unit 202 and a set of “VLAN ID”, “FIXED BANDWIDTH RATE”, and “MAXIMUM DROP RATE” can be set in the setting unit. Moreover, in the first embodiment, when the present invention is not applied to the VLAN, the input-number setting unit 202 can be eliminated.

The result screen 300 includes an entire status displaying unit 301, an individual status displaying unit 302, a VLAN ID displaying unit 303, an input rate displaying unit 304, and a drop rate displaying unit 305. When the packet drop rate of any one of the VLANs exceeds the maximum drop rate, the entire status displaying unit 301 displays a warning. When the packet drop rate exceeds the maximum drop rate in the corresponding VLAN, the individual status displaying unit 302 displays a warning. Such warnings are displayed by changing an indicator from a green color display (normal display) to a red color display (warning display).

The VLAN ID displaying unit 303 displays the VLAN ID that is set in the VLAN ID setting unit 203. The input rate displaying unit 304 displays for each VLAN, the bandwidth of the packet input into the VLAN, that is, the bandwidth before the bandwidth limitation. The input rate is the data retrieved by the bandwidth-data collecting unit 101.

The drop rate displaying unit 305 displays for each VLAN, the bandwidth of the packet output from the VLAN, that is, the bandwidth after the bandwidth limitation. The drop rate is the difference between the bandwidths before and after the bandwidth limitation that are retrieved by the bandwidth-data collecting unit 101. When the drop rate exceeds the maximum drop rate of the VLAN that is set in the maximum-drop-rate setting unit 205, a background color in a frame of the drop rate displaying unit 305 of the corresponding VLAN is changed to red for displaying a warning.

Thus, according to the first embodiment, “FIXED BANDWIDTH RATE” and “MAXIMUM DROP RATE” are set for each VLAN, and “INDIVIDUAL STATUS”, “INPUT RATE”, and “DROP RATE” according to the settings mentioned above are displayed for each VLAN. Due to this, an occurrence of a defect in any VLAN that the drop rate exceeds the maximum drop rate can be clearly detected in real time, thus enabling the user to take quick countermeasures.

According to the first embodiment, the difference between the bandwidth of the input packet and the fixed bandwidth is the bandwidth-limitation indicator which is to be evaluated, but is not limited thereto. For example, the difference between the bandwidth of the input packet and the bandwidth of the output packet, in other words, the difference between the bandwidths before and after the bandwidth limitation, may be the bandwidth-limitation indicator to be evaluated. In this case, when the line interface 106 is an input interface to the L2 switch 107 and the line interface 108 is an output interface from the L2 switch 107, the bandwidth-data collecting unit 101 retrieves the bandwidth data of the input packet from the line interface 106 and retrieves the bandwidth data of an output packet after the bandwidth limitation from the line interface 108. Further, when the line interface 108 is the input interface to the L2 switch 107 and the line interface 106 is the output interface from the L2 switch 107, the bandwidth-data collecting unit 101 retrieves the bandwidth data of the input packet from the line interface 108 and retrieves the bandwidth data of an output packet after the bandwidth limitation from the line interface 106.

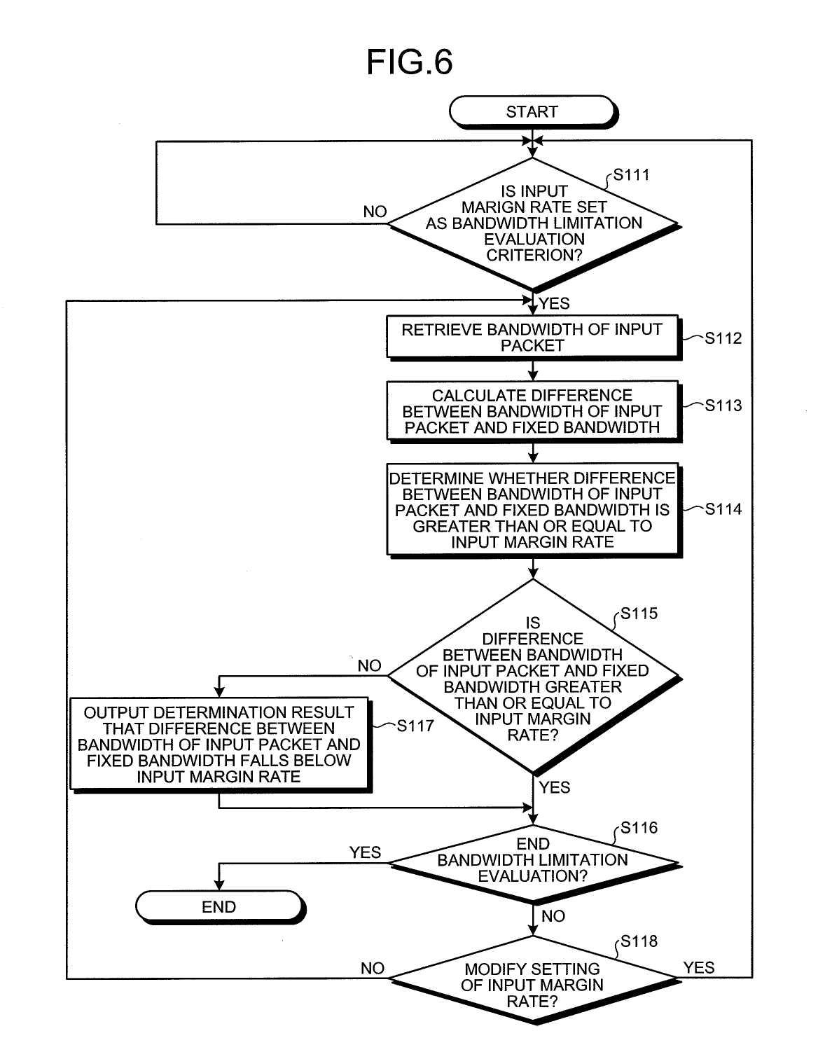

A second embodiment of the present invention will be explained below with reference to FIGS. 6 to 8. In the second embodiment, a lower limit of a margin bandwidth to the fixed bandwidth up to which a packet input is allowed is treated as the quality evaluation criterion of the traffic, and the comparison result of the difference between the bandwidth before the bandwidth limitation and the fixed bandwidth is output such that the comparison result can be displayed. In the L2 switch device 100 according to the second embodiment, when the difference between the bandwidth before the bandwidth limitation and the fixed bandwidth exceeds a minimum value of the margin bandwidth of the packet, a warning to the effect can be notified to the user. In the second embodiment, the minimum value of the margin bandwidth of the packet is treated as the evaluation criterion. Structures, functions, and processes in the second embodiment that are respectively the same as the structures, functions, and processes in the first embodiment will not be explained again and only the difference between the first and the second embodiments will be explained. A network used in the first embodiment is assumed to be the guarantee type network that guarantees the minimum bandwidth.

A structure of the L2 switch device 100 according to the second embodiment is basically the same as the structure of the L2 switch device 100 according to the first embodiment. The bandwidth-limitation-indicator evaluating unit 103 carries out a process to evaluate, based on the evaluation criterion 104a that is stored in the storage unit 104, the bandwidth limitation indicator calculated by the bandwidth-limitation-indicator calculating unit 102. To be specific, when the bandwidth limitation indicator is the difference between the bandwidth data before the bandwidth limitation and the bandwidth data of the fixed bandwidth, the bandwidth-limitation-indicator evaluating unit 103 determines whether the difference falls below the margin bandwidth (input margin rate) as the evaluation criterion. The evaluation criterion 104a indicates the evaluation criterion which is stored by securing a storage area in a storage unit, and the storage area.

A bandwidth limitation evaluating process according to the second embodiment will be explained next. FIG. 6 is a flowchart of the bandwidth limitation evaluating process according to the second embodiment. As shown in FIG. 6, first, the not shown controller which controls the entire L2 switch device 100 determines whether the input margin rate is set as the bandwidth limitation evaluation criterion (step S111). The bandwidth limitation evaluation criterion is the evaluation criterion 104a stored in the storage unit 104 and the minimum value of the margin bandwidth to the fixed bandwidth of the admissible input packet.

Next, the bandwidth-data collecting unit 101 retrieves the bandwidth of the input packet (step S112). The bandwidth-limitation-indicator calculating unit 102 calculates the difference between the bandwidth of the input packet and the fixed bandwidth (step S113).

Next, the bandwidth-limitation-indicator evaluating unit 103 determines whether the difference between the bandwidth of the input packet and the fixed bandwidth is greater than or equal to the input margin rate as the evaluation criterion 104a stored in the storage unit 104 (step S114). When the bandwidth-limitation-indicator evaluating unit 103 determines that the difference between the bandwidth of the input packet and the fixed bandwidth is greater than or equal to the input margin rate (“Yes” at step S115), the bandwidth limitation evaluating process moves to step S116. When the bandwidth-limitation-indicator evaluating unit 103 determines that the difference between the bandwidth of the input packet and the fixed bandwidth is not greater than or equal to the input margin rate (“No” at step S115), the bandwidth limitation evaluating process moves to step S117.

At step S116, the controller of the L2 switch device 100 determines whether to end the bandwidth limitation evaluation. When the controller determines to end the bandwidth limitation evaluation (“Yes” at step S116), the controller immediately ends the bandwidth limitation evaluating process. When the controller determines not to end the bandwidth limitation evaluation (“No” at step S116), the bandwidth limitation evaluating process moves to step S118.

At step S117, the bandwidth-limitation-evaluation-result outputting unit 105 outputs the evaluation result to the effect that the difference between the bandwidth of the input packet and the fixed bandwidth falls below the input margin rate. Upon completion of step S117, the bandwidth limitation evaluating process moves to step S116.

At step S118, the controller of the L2 switch device 100 determines whether to modify the setting of the input margin rate. When the controller determines to modify the setting of the input margin rate (“Yes” at step S118), the bandwidth limitation evaluating process moves to step S111. When the controller determines not to modify the setting of the input margin rate (“No” at step S118), the bandwidth limitation evaluating process moves to step S112.

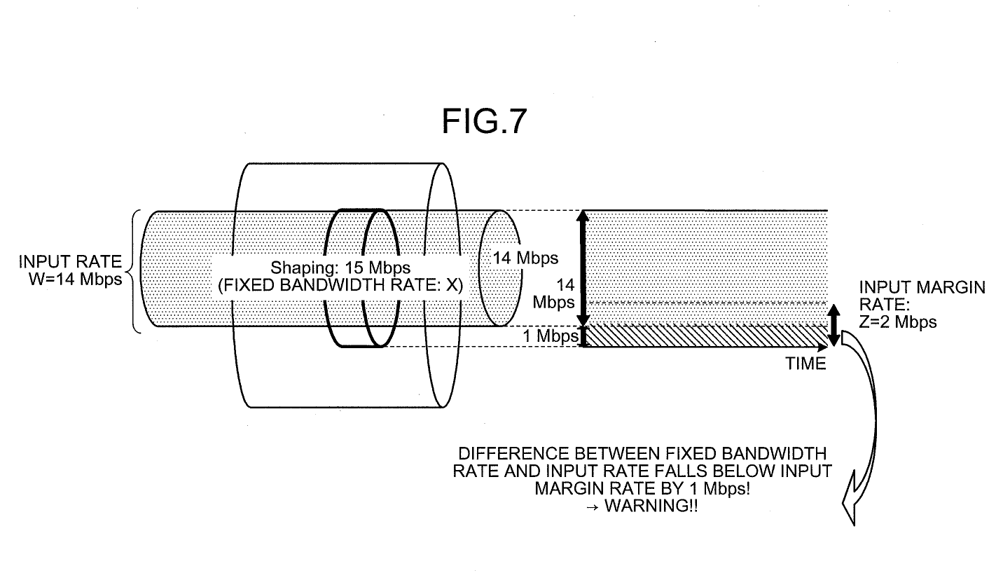

An example of an operation using the bandwidth limitation evaluating process according to the second embodiment will be explained next. FIG. 7 is a schematic of the example of the operation using the bandwidth limitation evaluating process according to the second embodiment. As shown in FIG. 7, when the input rate (the bandwidth of the input packet) is 14 Mbps and an input margin rate is Z=2 Mbps, an output bandwidth is assumed to be 14 Mbps. When carrying out the bandwidth limitation, the fixed bandwidth rate, as the maximum bandwidth up to which the packet input is allowed, is 15 Mbps. However, the difference between the fixed bandwidth rate and the input rate, that is, 1 Mbps calculated by subtracting 14 from 15, falls below the input margin rate Z=2 Mbps by 1 Mbps. Then, a warning is notified to the user. In the second embodiment, the traffic is constantly monitored using the bandwidth limitation evaluation. Thus, the user can be notified of a defect in the network timely (at the appropriate time) and in real time (immediately).

The second embodiment of the invention is explained above. However, the present invention can be similarly applied to the relay and transferring process of the VLAN packet in the VLAN or the VPN packet in the VPN. When carrying out the relay and transferring process of data, the bandwidth-data collecting unit 101 retrieves the bandwidth data of the input packet and the bandwidth data of the output packet after the bandwidth limitation from the L2 switch 107 that processes the packets in VLAN units or VPN units. For example, the fixed bandwidth rate of X Mbps is stipulated for each VLAN that is identified by the VLAN ID and shaping (bandwidth limitation) is used to limit the input rate of W Mbps to the fixed bandwidth rate of X Mbps. When Z Mbps is the input margin rate, and X-W becomes less than Z, a notice is notified to the user. Further, similarly to the VLAN, the fixed bandwidth rate of X Mbps is stipulated for each VPN that is identified by a VPN identifier and shaping (bandwidth limitation) is used to limit the input rate of W Mbps to the fixed bandwidth rate of X Mbps.

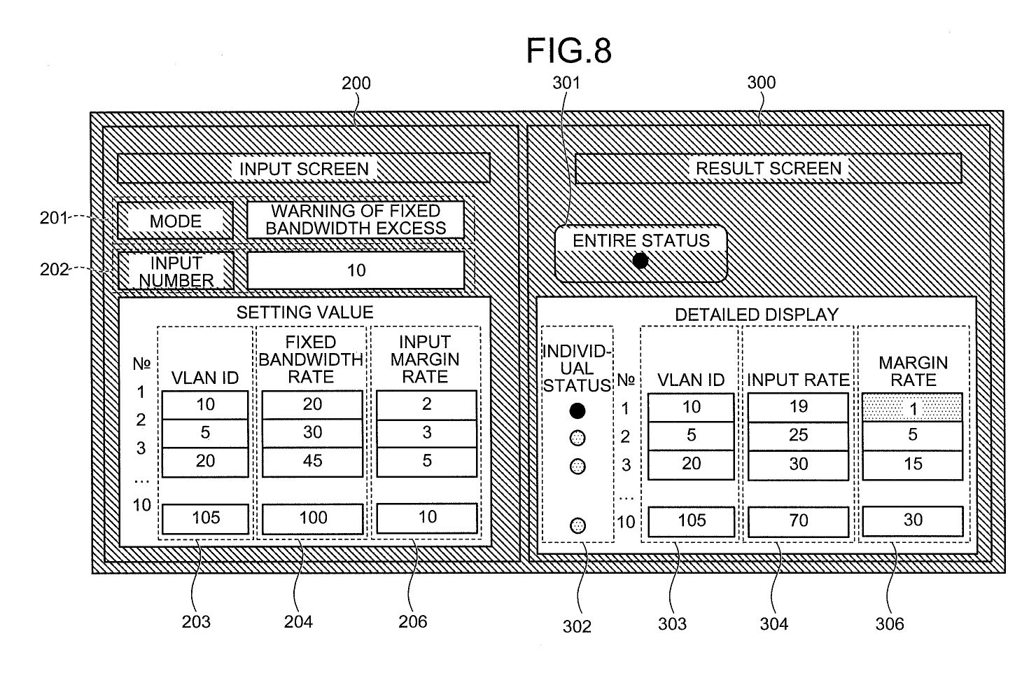

The input/output interface according to the second embodiment will be explained next. FIG. 8 is a schematic of the input/output interface according to the second embodiment. The input/output interface shown in FIG. 8 is the screen image of the input/output interface 151 shown in FIG. 2.

The input/output interface includes the input screen 200 for selecting and setting the evaluation criterion 104a and the result screen 300 for displaying the evaluation result. The input screen 200 includes the mode setting unit 201, the input-number setting unit 202, the VLAN ID setting unit 203, the fixed-bandwidth-rate setting unit 204, and an input-margin-rate setting unit 206.

The mode setting unit 201 is the entry that selects and sets any one of “WARNING OF FIXED BANDWIDTH EXCESS”, “NOTICE OF FIXED BANDWIDTH EXCESS”, and “BEST EFFORT”. In the second embodiment, when the bandwidth of the input packet approximates the fixed bandwidth as the maximum bandwidth of the admissible input packet, a notice is notified to the user. Therefore in FIG. 8, “NOTICE OF FIXED BANDWIDTH EXCESS” is selected in the input/output interface according to the second embodiment. The “NOTICE OF FIXED BANDWIDTH EXCESS” is a mode that sets for each VLAN, the fixed bandwidth as the maximum bandwidth allowed for the input packet and the input margin rate that is the lower limit allowing a proximity of the bandwidth of the input packet to the fixed bandwidth. Upon selecting the “NOTICE OF FIXED BANDWIDTH EXCESS” mode, when the proximity of the bandwidth of the input packet to the fixed bandwidth falls below the input margin rate, a notice is notified to the user.

The input-number setting unit 202 is the entry that sets a number of the VLANs to be input. In the example shown in FIG. 8, because the number of the VLAN is “10”, “10” is set in the input-number setting unit 202. According to the setting value in the input-number setting unit 202, “VLAN ID”, “FIXED BANDWIDTH RATE”, and “INPUT MARGIN RATE” with respect to ten VLANs can be set respectively in the VLAN ID setting unit 203, the fixed-bandwidth-rate setting unit 204, and the input-margin-rate setting unit 206 that form the setting unit.

In the VLAN ID setting unit 203, the ID of the VLAN subjected to the bandwidth limitation evaluation is set. In the fixed-bandwidth-rate setting unit 204, the minimum bandwidth, which is guaranteed to the VLAN subjected to the bandwidth limitation evaluation, is set. In the input-margin-rate setting unit 206, the lower limit of the admissible input margin rate, for the VLAN subjected to the bandwidth limitation evaluation, is set. Thus, with the various setting values, each VLAN is subjected to the bandwidth limitation evaluation and is subjected to the traffic quality monitoring.

In the second embodiment, when the present invention is not applied to the VLAN, “1” is fixedly set in the input-number setting unit 202 and the set of “VLAN ID”, “FIXED BANDWIDTH RATE”, and “INPUT MARGIN RATE” can be set in the setting unit. Moreover, in the second embodiment, when the present invention is not applied to the VLAN, the input-number setting unit 202 can be eliminated.

The result screen 300 includes the entire status displaying unit 301, the individual status displaying unit 302, the VLAN ID displaying unit 303, the input rate displaying unit 304, and a margin rate displaying unit 306. When a margin rate of the packet in any of the VLANs falls below the input margin rate, the entire status displaying unit 301 displays a notice. When the fixed bandwidth rate is X Mbps and the input rate is W Mbps, the margin rate is represented by X-W.

When the margin rate falls below the input margin rate in the corresponding VLAN, the individual status displaying unit 302 displays a notice. Such notices are displayed by changing the indicator from the green color display (normal display) to the red color display (noticing display).

The VLAN ID displaying unit 303 displays the VLAN ID that is set in the VLAN ID setting unit 203. The input rate displaying unit 304 displays for each VLAN, the bandwidth of the packet input into the VLAN, that is, the bandwidth before the bandwidth limitation. The input rate is the data retrieved by the bandwidth-data collecting unit 101.

The margin rate displaying unit 306 displays for each VLAN the margin rate, which is the difference between the bandwidth of the packet input from the VLAN and the fixed bandwidth. In other words, the margin rate is the difference between the input rate and the fixed rate that are retrieved by the bandwidth-data collecting unit 101. When the margin rate falls below the input margin rate of the VLAN that is set in the input-margin-rate setting unit 206, the background color in the frame of the margin rate displaying unit 306 of the corresponding VLAN is changed to red for displaying a notice.

Thus, according to the second embodiment, “FIXED BANDWIDTH RATE” and “INPUT MARGIN RATE” are set for each VLAN and “INDIVIDUAL STATUS”, “INPUT RATE”, and “MARGIN RATE” according to the settings mentioned above are displayed for each VLAN. Due to this, an occurrence of a defect in any VLAN that the margin rate falls below the input margin rate can be clearly detected in real time, thus enabling the user to take quick countermeasures.

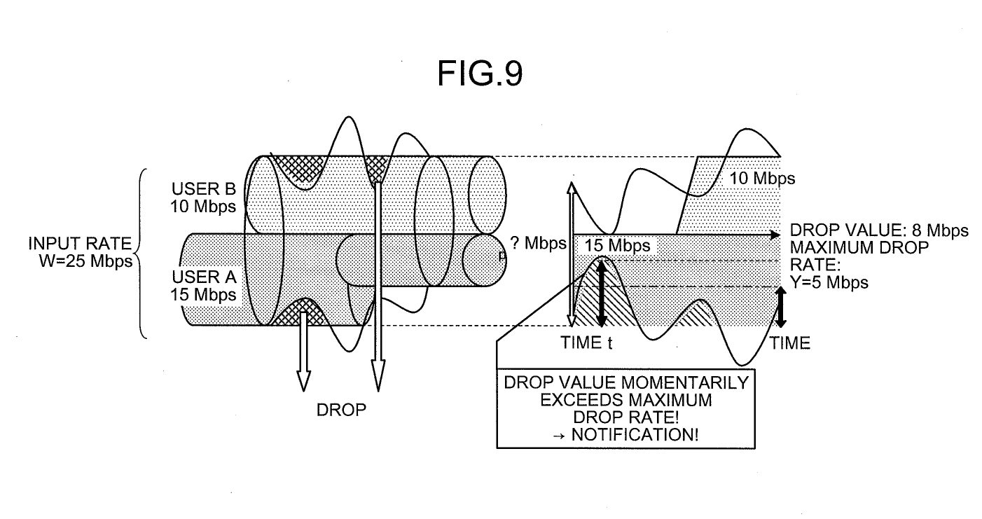

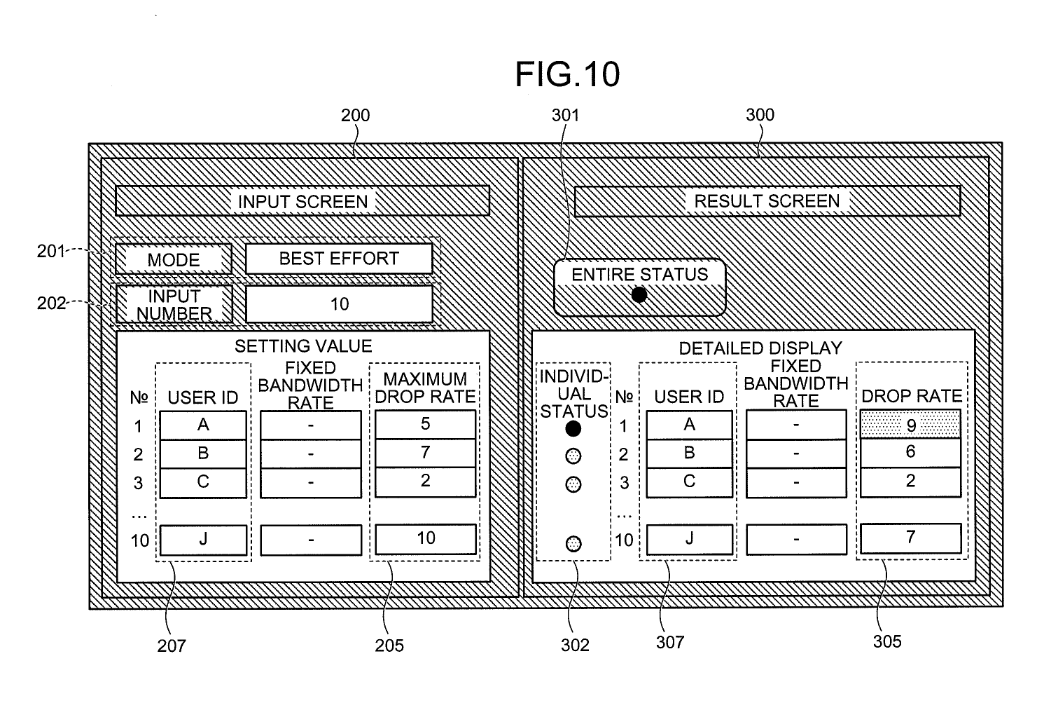

The third embodiment of the present invention will be explained below with reference to FIGS. 9 and 10. In a best effort type network used in the third embodiment, the upper limit of the admissible packet-dropping bandwidth related to the packet drop using the bandwidth limitation is treated as the quality evaluation criterion of the traffic, and the comparison result of the difference between the bandwidth before the bandwidth limitation and the bandwidth after the bandwidth limitation is output such that the comparison result can be displayed. In the L2 switch device 100 according to the third embodiment, when the difference between the bandwidth before the bandwidth limitation and the bandwidth after the bandwidth limitation exceeds the maximum value of the packet-dropping bandwidth, such an excess can be notified to the user as a warning. In the third embodiment, the maximum value of the packet-dropping bandwidth is treated as the evaluation criterion. Structures, functions and processes in the third embodiment that are the same as the respective structures, functions, and processes in the first or the second embodiment will not be explained again and only the difference from the first or the second embodiment will be explained.

An example of an operation using the bandwidth limitation evaluating process according to the third embodiment will be explained first. FIG. 9 is a schematic of the example of the operation using the bandwidth limitation evaluating process according to the third embodiment. As shown in FIG. 9, when the input rate (the bandwidth of the input packet) of a user A is 15 Mbps, the input rate of a user B is 10 Mbps, and the maximum drop rate is Y=5 Mbps, shaping (bandwidth limitation) or characteristics of a best effort type line is used to momentarily limit the bandwidth of the user A to 7 Mbps and a bandwidth of 8 Mbps is dropped. When carrying out the bandwidth limitation, the drop rate of 8 Mbps, which is calculated by subtracting 7 from 15, is greater than 5 Mbps and the drop rate exceeds the maximum drop rate of Y=5 Mbps by 3 Mbps. Due to the drop rate exceeding the maximum drop rate, a warning is notified to the user. In the third embodiment, the traffic is constantly monitored using the bandwidth limitation evaluation. Thus, the user can be notified of a defect in the network timely (at the appropriate time) and in real time (immediately).

The input/output interface according to the third embodiment will be explained next. FIG. 10 is a schematic of the input/output interface according to the third embodiment. The input/output interface shown in FIG. 10 is the screen image of the input/output interface 151 shown in FIG. 2.

The input/output interface includes the input screen 200 for selecting and setting the evaluation criterion 104a and the result screen 300 for displaying the evaluation result. The input screen 200 and the result screen 300 may be displayed in a single screen. The input screen 200 and the result screen 300 may otherwise be separated to single screens and displayed, respectively.

The input screen 200 includes the mode setting unit 201, the input-number setting unit 202, a user setting unit 207, and the maximum-drop-rate setting unit 205.

The mode setting unit 201 is the entry that selects and sets any one of “WARNING OF FIXED BANDWIDTH EXCESS”, “NOTICE OF FIXED BANDWIDTH EXCESS”, and “BEST EFFORT”. In the best effort type network according to the third embodiment, when the drop rate due to the packet drop exceeds the maximum drop rate that is allowed for the packet drop, a warning is notified to the user. Therefore in FIG. 10, “BEST EFFORT” is selected in the input/output interface according to the third embodiment. The “BEST EFFORT” is a mode that sets for each user, the maximum drop rate as the upper limit allowing the packet drop. Upon selecting the “BEST EFFORT” mode, when the drop rate of the packet exceeds the admissible maximum drop rate, a warning is notified to the user.

The input-number setting unit 202 is the entry that sets a number of the users to be input. In the example shown in FIG. 10, because the number of the users is “10”, “10” is set in the input-number setting unit 202. According to the setting value in the input-number setting unit 202, “USER ID” and “MAXIMUM DROP RATE” with respect to ten users can be set respectively in the user setting unit 207 and the maximum-drop-rate setting unit 205 that form the setting unit.

In the user setting unit 207, the ID of the user who is subjected to the bandwidth limitation evaluation is set. In the maximum-drop-rate setting unit 205, the upper limit of the admissible packet drop rate for the user who is subjected to the bandwidth limitation evaluation is set. Thus, with the various setting values, each user is subjected to the bandwidth limitation evaluation and is subjected to the traffic quality monitoring.

The result screen 300 includes the entire status displaying unit 301, the individual status displaying unit 302, a user displaying unit 307, and the drop rate displaying unit 305. When the packet drop rate of the bandwidth of any user exceeds the maximum drop rate, the entire status displaying unit 301 displays a warning. When the packet drop rate exceeds the maximum drop rate in the bandwidth of the corresponding user, the individual status displaying unit 302 displays a warning. Such warnings are displayed by changing the indicator from the green color display (normal display) to the red color display (warning display).

The user displaying unit 307 displays the user ID that is set in the user setting unit 207. The drop rate displaying unit 305 displays for each user, the bandwidth of each user, that is, the bandwidth after the bandwidth limitation. The drop rate is the difference between the bandwidths before and after the bandwidth limitation that are retrieved by the bandwidth-data collecting unit 101. When the drop rate exceeds the maximum drop rate of the user that is set in the maximum-drop-rate setting unit 205, the background color in the frame of the drop rate displaying unit 305 of the corresponding user is changed to red for displaying a warning.

Thus, according to the third embodiment, “MAXIMUM DROP RATE” is set for each user and “INDIVIDUAL STATUS” and “DROP RATE” according to the setting mentioned above are displayed for each user. Due to this, an occurrence of a defect in any user that the drop rate exceeds the maximum drop rate, can be clearly detected in real time, thus enabling the user to take quick countermeasures.

The first to the third embodiments of the present invention are explained above. However, the present invention is not to be thus limited, and various modifications may be made without departing from the spirit or scope of the general inventive concept as defined by the appended claims and their equivalents. Further, the effects described in the first to the third embodiments are not to be thus limited.

Using the communication relay device according to the present invention in a network structure enables to construct a network monitoring system that has easiness in use and high maintainability without necessitating a complex structure, setup of specific steps, or settings etc.

All the automatic processes explained in the first to the third embodiments can be, entirely or in part, carried out manually. Similarly, all the manual processes explained in the embodiments can be, entirely or in part, carried out automatically by a known method. The sequence of processes, the sequence of controls, specific names, and data including various parameters explained in the first to the third embodiments can be changed as required unless otherwise specified.

The constituent elements of the device illustrated in the drawings are merely conceptual and may not necessarily physically resemble the shown structures. In other words, the device, as a whole or in part, can be broken down or integrated either functionally or physically in accordance with the load or how the device is to be used.

The process functions performed by the device are entirely or partially realized by a central processing unit (CPU) and a computer program executed by the CPU. Instead of the CPU, a micro computer such as a micro processing unit (MPU) and a micro controller unit (MCU) may be used. Otherwise, the process functions may, entirely or partially, be realized by a hardware using a wired logic.

According to one aspect of the invention, a performance deterioration of a communication network can be quickly detected and immediate countermeasures against the performance deterioration can be taken.

According to another aspect of the invention, a quality deterioration of the communication network due to a bandwidth limitation can be quickly detected and immediate countermeasures against the quality deterioration can be taken.

According to still another aspect of the invention, quick countermeasures can be taken according to an evaluation result.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication relay device that relays in a communication network, input data that is input from a line to another line as output data, comprising:
an evaluation-criterion setting unit that in advance sets, based on the input data and the output data, an evaluation criterion that is arbitrarily set for evaluating a performance of the communication network;
an indicator calculating unit that calculates, based on the input data and the output data, a performance indicator of the communication network; and
an evaluating unit that evaluates, based on the performance indicator calculated by the indicator calculating unit and the evaluation criterion set in advance by the evaluation-criterion setting unit, the performance of the communication network.

2. The communication relay device according to claim 1, wherein
one of a virtual local area network (VLAN) packet in a VLAN and a virtual private network (VPN) packet in a VPN is relayed in the communication network,
the evaluation-criterion setting unit can set the evaluation criterion with respect to one of the VLAN and the VPN,
the indicator calculating unit calculates, with respect to one of the VLAN and the VPN, one of the performance indicator and the bandwidth limitation indicator, and
the evaluating unit evaluates, with respect to one of the VLAN and the VPN, one of the performance and the bandwidth limitation of the communication network.

3. A communication relay device that relays in a communication network, a communication bandwidth of input data that is input from a line and subjected to a bandwidth limitation to a predetermined bandwidth, to another line as output data, comprising:
an evaluation-criterion setting unit that in advance sets an evaluation criterion that is arbitrarily set for evaluating the bandwidth limitation;
an indicator calculating unit that calculates a bandwidth limitation indicator based on the communication bandwidth of the input data and one of the predetermined bandwidth and a communication bandwidth of the output data after the bandwidth limitation; and
an evaluating unit that evaluates, based on the bandwidth limitation indicator calculated by the indicator calculating unit and the evaluation criterion set in advance by the evaluation-criterion setting unit, the bandwidth limitation.

4. The communication relay device according to claim 3, wherein
the bandwidth limitation indicator is a limited bandwidth that is limited using the bandwidth limitation,
the evaluation criterion is an upper limit of the limited bandwidth, and
the evaluating unit evaluates, when the bandwidth limitation indicator exceeds the upper limit, that the bandwidth limitation exceeds an upper limit.

5. The communication relay device according to claim 3, wherein
the bandwidth limitation indicator is a difference between the communication bandwidth of the input data and the predetermined bandwidth,
the evaluation criterion is a lower limit of the difference, and
the evaluating unit evaluates, when the bandwidth limitation indicator falls below the lower limit, that the communication bandwidth of the input data exceeds an upper limit.

6. The communication relay device according to claim 3, further comprising an evaluation-result outputting unit that outputs in real time, an evaluation result by the evaluating unit such that the evaluation result can be displayed.

7. The communication relay device according to claim 3, wherein
one of a virtual local area network (VLAN) packet in a VLAN and a virtual private network (VPN) packet in a VPN is relayed in the communication network,
the evaluation-criterion setting unit can set the evaluation criterion with respect to one of the VLAN and the VPN,
the indicator calculating unit calculates, with respect to one of the VLAN and the VPN, one of the performance indicator and the bandwidth limitation indicator, and
the evaluating unit evaluates, with respect to one of the VLAN and the VPN, one of the performance and the bandwidth limitation of the communication network.

8. A communication relay method of relaying in a communication network, input data that is input from a line to another line as output data, comprising:
setting an evaluation criterion that is arbitrarily set for evaluating a performance of the communication network in advance based on the input data and the output data;
calculating a performance indicator of the communication network based on the input data and the output data; and
evaluating the performance of the communication network based on the performance indicator calculated in the calculating and the evaluation criterion set in advance in the setting.

9. The communication relay method according to claim 8, wherein
one of a virtual local area network (VLAN) packet in a VLAN and a virtual private network (VPN) packet in a VPN is relayed in the communication network,
the evaluation criterion can be set in the setting with respect to one of the VLAN and the VPN,
one of the performance indicator and the bandwidth limitation indicator is calculated in the calculating with respect to one of the VLAN and the VPN, and
one of the performance and the bandwidth limitation of the communication network is evaluated in the evaluating with respect to one of the VLAN and the VPN.

10. A communication relay method of relaying in a communication network, a communication bandwidth of input data that is input from a line and subjected to a bandwidth limitation to a predetermined bandwidth, to another line as output data, comprising:
setting an evaluation criterion that is arbitrarily set for evaluating the bandwidth limitation in advance;
calculating a bandwidth limitation indicator based on the communication bandwidth of the input data and one of the predetermined bandwidth and a communication bandwidth of the output data after the bandwidth limitation; and
evaluating the bandwidth limitation based on the bandwidth limitation indicator calculated in the calculating and the evaluation criterion set in advance in the setting.

11. The communication relay method according to claim 10, wherein
the bandwidth limitation indicator is a limited bandwidth that is limited using the bandwidth limitation,
the evaluation criterion is an upper limit of the limited bandwidth, and
the evaluating includes evaluating, when the bandwidth limitation indicator exceeds the upper limit, that the bandwidth limitation exceeds the upper limit.

12. The communication relay method according to claim 10, wherein
the bandwidth limitation indicator is a difference between the communication bandwidth of the input data and the predetermined bandwidth,
the evaluation criterion is a lower limit of the difference, and
the evaluating includes evaluating, when the bandwidth limitation indicator falls below the lower limit, that the communication bandwidth of the input data exceeds an upper limit.

13. The communication relay method according to claim 10, further comprising outputting in real time, an evaluation result made in the evaluating such that the evaluation result can be displayed.

14. The communication relay method according to claim 10, wherein
one of a virtual local area network (VLAN) packet in a VLAN and a virtual private network (VPN) packet in a VPN is relayed in the communication network,
the evaluation criterion can be set in the setting with respect to one of the VLAN and the VPN,
one of the performance indicator and the bandwidth limitation indicator is calculated in the calculating with respect to one of the VLAN and the VPN, and
one of the performance of the communication network and the bandwidth limitation is evaluated in the evaluating with respect to one of the VLAN and the VPN.

15. A computer-readable recording medium that stores therein a communication relay process program that causes a computer to perform a communication relay process of relaying input data that is input from one line to another line as output data, the communication relay process program causing the computer to execute:
setting an evaluation criterion that is arbitrarily set for evaluating a performance of the communication network in advance based on the input data and the output data;
calculating a performance indicator of the communication network based on the input data and the output data; and
evaluating the performance of the communication network based on the performance indicator calculated in the calculating and the evaluation criterion set in advance in the setting.
